(19) United States
(12) Patent Application Publication
(10) Pub. No.: US 2013/0273969 A1
(43) Pub. Date: Oct. 17, 2013

(54) MOBILE APP THAT GENERATES A DOG SOUND TO CAPTURE DATA FOR A LOST PET IDENTIFYING SYSTEM

(71) Applicant: Finding Rover, Inc., Brentwood, CA (US)

(72) Inventor: John Polimeno, Byron, CA (US)

(21) Appl. No.: 13/912,204

(22) Filed: Jun. 7, 2013

Related U.S. Application Data
(63) Continuation-in-part of application No. 13/610,877, filed on Sep. 12, 2012.
(60) Provisional application No. 61/565,962, filed on Dec. 1, 2011.

(51) Int. Cl. G06K 9/20

(52) U.S. Cl. CPC G06K 9/2081
USPC 455/556.1

(57) ABSTRACT

A mobile app causes a dog attention grabber button to be displayed on a touch screen of a wireless mobile communication device. The user presses the button, and in response the device generates a dog vocalization sound. In response, the dog looks in the direction of the device in an attempt to locate the origin of the sound. The user then presses a shutter button that is also displayed on the touch screen. As a result, camera functionality of the device captures a digital image of the dog. The user is prompted to manipulate the image, and to identify facial features in the image. If the collected information is deemed suitable, then it is sent (for example, by wireless communication and across the internet) to a destination under control of the mobile app for further use by a facial recognition and lost pet identifying system.

### CROSS-REFERENCE TO RELATED APPLICATIONS

This application is a continuation-in-part of, and claims the benefit under 35 U.S.C. §120 from, nonprovisional U.S. patent application Ser. No. 13/610,877, entitled “Facial Recognition Lost Pet Identifying System”, filed on Sep. 12, 2012. U.S. patent application Ser. No. 13/610,877 claims the benefit under 35 U.S.C. §119 from provisional U.S. patent application Ser. No. 61/565,962, entitled “Facial Recognition Lost Pet Identifying System”, filed Dec. 1, 2011. This application incorporates by reference U.S. patent application Ser. No. 13/610,877. This application also incorporates by reference provisional U.S. patent application Ser. No. 61/565,962.

### TECHNICAL FIELD

The described embodiments relate generally to systems for identifying lost pets and reuniting them with their owners.

### BACKGROUND INFORMATION

There are currently approximately seventy-eight million pet dogs in the United States. An estimated ten million of these pets go missing each year. Previously existing internet-based lost pet locating systems have various shortcomings and have not been widely adopted. Sadly, only a very small percentage of the ten million missing dogs (ten to fifteen percent) are found and returned to their owners.

### SUMMARY

A mobile application (“mobile app”) executes on a wireless mobile communication device and is usable to generate digital image information of a dog, where the digital image information is suitable for further use by a facial recognition process of a lost pet identifying system. In one specific example, the wireless mobile communication device is an iPhone or similar device that has a touch screen. The user activates the mobile app and is prompted to take a digital photograph of the dog using the wireless mobile communication device. A dog attention grabber button is displayed on the touch screen. The user presses this dog attention grabber button on the touch screen, and in response the wireless mobile communication device generates a dog vocalization sound. The dog vocalization sound may be a whimper, and is typically generated by playing a digital audio file stored on the wireless mobile communication device. The user can press the dog attention grabber button multiple times, so that the dog vocalization sound is generated multiple times at the direction of the user.

In response to the dog vocalization sound emanating from the wireless mobile communication device, the dog looks in the direction of the wireless mobile communication device in an attempt to locate the origin of the dog vocalization sound. The user then presses a shutter button that is also displayed on the touch screen. As a result of the pressing of the shutter button, a camera functionality of the wireless mobile communication device captures a digital image of the dog.

The user is then prompted, under control of the mobile app, to manipulate the captured digital image in particular ways, for example by rotating the image so that the dog's face is level (not tilted), and by expanding or reducing the size of the image so that the dog's face is properly scaled. The user is then prompted, again under the control of the mobile app, to use the touch screen to identify certain facial features of the dog. In one example the user is prompted to place circle symbols over the eyes of the dog in the image, and the user is prompted to place a triangle symbol over the nose of the dog in the image. Information from this placement is captured by the mobile app. The mobile app then checks determines whether the collected digital image information as collected is suitable for further use by the facial recognition process of the lost pet identifying system. If the determination is that the collected information is suitable, then the collected information is sent (for example, by wireless communication and across the internet) to a destination under control of the mobile app. If the determination is that the collected information is not suitable, then the mobile app causes the user to be prompted to try the image capture process again.

The image capturing method set forth above is controlled by the mobile app, and is part of a broader pet registration process that is carried out by the same mobile app. The collected information that communicated from the wireless mobile communication device is then used by a facial recognition lost pet identifying system executing on a remote server. The mobile app is usable by the user to interact with the system.

Further details and embodiments and techniques are described in the detailed description below. This summary does not purport to define the invention. The invention is defined by the claims

### BRIEF DESCRIPTION OF THE DRAWINGS

The accompanying drawings, where like numerals indicate like components, illustrate embodiments of the invention.

FIG. 1A is a first part of a flowchart of a method 50 in accordance with one novel aspect.

FIG. 1B is a second part of the flowchart the method 50. Together, FIGS. 1A and 1B form the flowchart of method 50.

FIG. 2 is a perspective diagram of a user photographing a dog utilizing a mobile application (mobile app) executing on a wireless mobile communication device.

FIG. 3 is a diagram showing the mobile app prompting the user either to upload a digital image of a dog or to capture a digital image of a dog.

FIG. 4 is a diagram showing the mobile app detecting user input to generate a dog vocalization sound. The mobile app causes a dog attention grabber button to be displayed on the screen of the wireless mobile communication device, and the user presses the button to cause a dog vocalization sound to be generated by the wireless mobile communication device.

FIG. 5 is a diagram showing the mobile app prompting the user to rotate a digital image of the dog until the eyes of the dog in the image appear level on the screen on of the wireless mobile communication device.

FIG. 6 is a diagram showing the mobile app prompting the user to scale the digital image of the dog to fit within an indicated triangular portion of the screen of the wireless mobile communication device.

FIG. 7 is a diagram showing the mobile app prompting the user to identify the eyes of the dog in the digital image.

FIG. 8 is a diagram showing the mobile app prompting the user to identify the nose of the dog in the digital image.

FIG. 9 is a diagram showing the mobile app notifying the user that the digital image is acceptable for use in further facial recognition method steps of the Finding Rover system.

FIG. 10 is flowchart of a method 100 of building a database of records, where each record includes information about a different pet including facial recognition markers and including owner identification information.

FIG. 11 is a flowchart of a method 200 of identifying a lost pet and contacting the pet's owner.

FIG. 12 is a diagram of a registration screen that an owner uses to register a pet with the FR system.

FIG. 13 is a diagram of information displayed on the cellular telephone of a finding user after the FR system has identified a matching record.

FIG. 14 is a diagram of an embodiment of the FR system.

FIG. 15A is a first part of a flowchart of a method 500 involving the FR system in accordance with one novel aspect.

FIG. 15B is a second part of the flowchart of the method 500.

FIG. 15C is a third part of the flowchart of the method of 500. Together, FIGS. 15A, 15B and 15C form the flowchart of method 500.

### DETAILED DESCRIPTION

Reference will now be made in detail to some embodiments of the invention, examples of which are illustrated in the accompanying drawings.

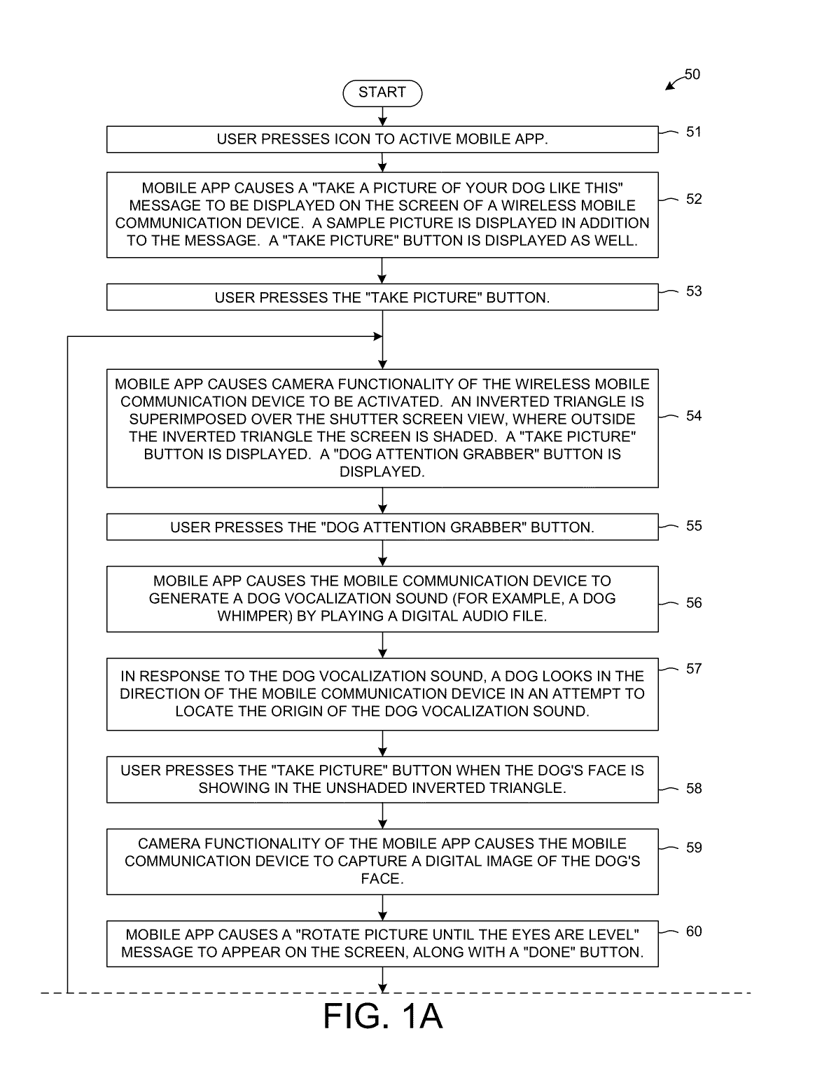

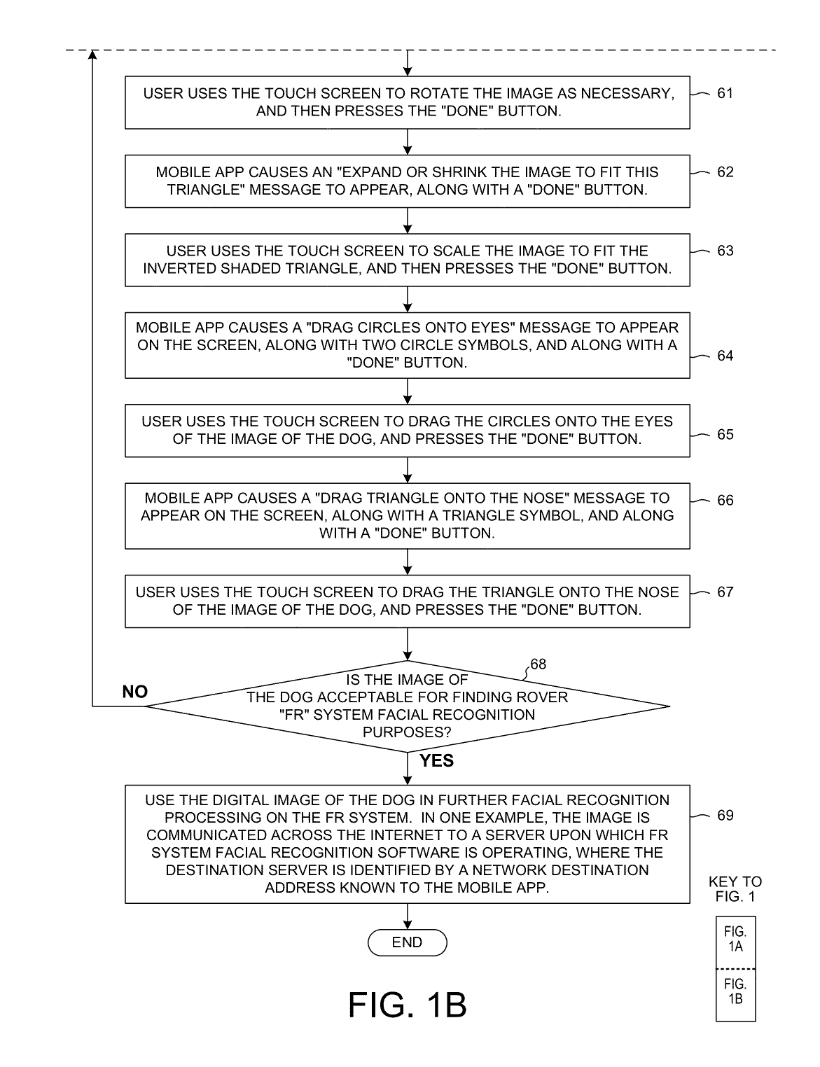

FIG. 1 includes FIGS. 1A and 1B which together are a flowchart of a method 50 in accordance with one novel aspect.

In a first step (step 51) of the method 50, a user presses an icon of a mobile application (“mobile app”), thereby activating the mobile app. For example, in FIG. 1, a user 71 presses an icon that is displayed on the touch screen of a wireless mobile communication device 72. In interacting with the mobile app, the user provides user input and makes selections by pressing mechanical buttons or pressing on electronically rendered buttons or uttering voice commands or pressing on a touch pad or making mouse clicks or pressing on keyboard keys or any other way that the particular wireless mobile communication device is configured to receive user input. In the specific example of FIG. 1, the wireless mobile communication device 72 is an iPhone available from Apple Computer of Cupertino, Calif. The icon is one of the icons displayed on a Home Screen of the iPhone 72. The Home Screen of the iPhone 72 displays icons that allow the user 71 to navigate and selectively activate mobile apps of the iPhone 72.

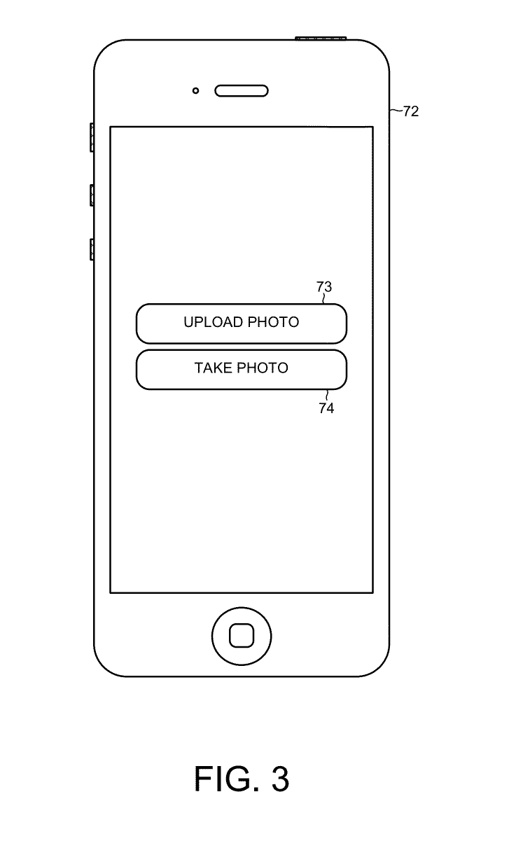

In a second step (step 52) of the method 50, the mobile app causes a “TAKE A PICTURE OF YOUR DOG LIKE THIS” message to be displayed on the screen of a wireless mobile communication device. A sample picture is displayed in addition to the message. A “TAKE PICTURE” button or key is displayed as well. For example, in the example of FIG. 3, the mobile app renders an “UPLOAD PHOTO” button 73 and a “TAKE PHOTO” button 74. The mobile app also renders a sample picture of a dog and a message “take a picture of your dog like this” (not shown). As indicated in FIG. 3 with the “TAKE PICTURE” button actually saying “TAKE PHOTO” on the illustrated screen, it is to be understood the actual wording and form that a particular functional button takes can vary from embodiment of the mobile app to embodiment of the mobile app.

In a third step (step 53), the user presses the “TAKE PICTURE” button. For example, in FIG. 3, the user 71 presses the “TAKE PHOTO” button 74.

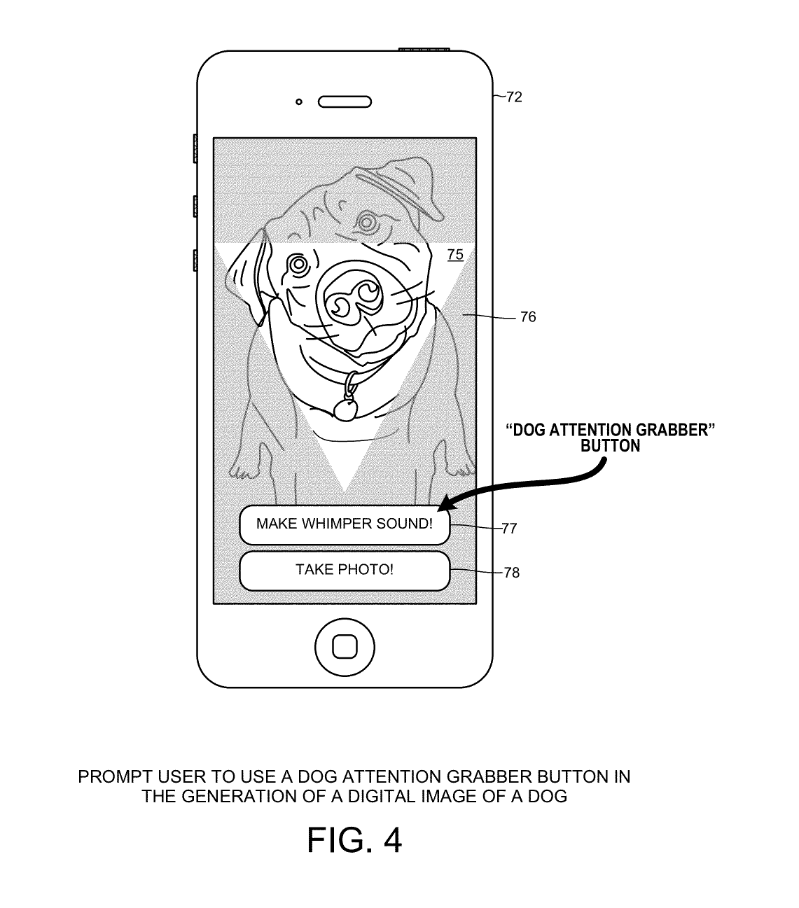

In a fourth step (step 54), the mobile app causes camera functionality of the wireless mobile communication device to be activated. An inverted triangle is superimposed over the shutter screen view, and the area outside the inverted triangle screen is shaded. This shaded triangle serves to provide the user a sort of visual target in which to place the face of the dog. A “TAKE PICTURE” button is displayed. A “DOG ATTENTION GRABBER” button is displayed. For example, in FIG. 4, the mobile app running on the iPhone 72 causes the iPhone camera functionality to be activated. An inverted triangle 75 is superimposed over the shutter screen view. Reference numeral 76 identifies a shaded area outside the inverted triangle screen. The mobile app renders a “MAKE WHIMPER SOUND!” button 77 and a “TAKE PHOTO!” button 78.

In a fifth step (step 55), the user presses the “DOG ATTENTION GRABBER” button. For example, in FIG. 4, the user 71 presses the “MAKE WHIMPER SOUND!” button 77. The exact way the button is displayed and/or the exact textual label that appears on the button, can vary from embodiment to embodiment. In some embodiments, there is no text but rather the button itself is in the form of a self-explanatory or suggestive icon that communicates to the user that pressing the button will cause a sound to be generated.

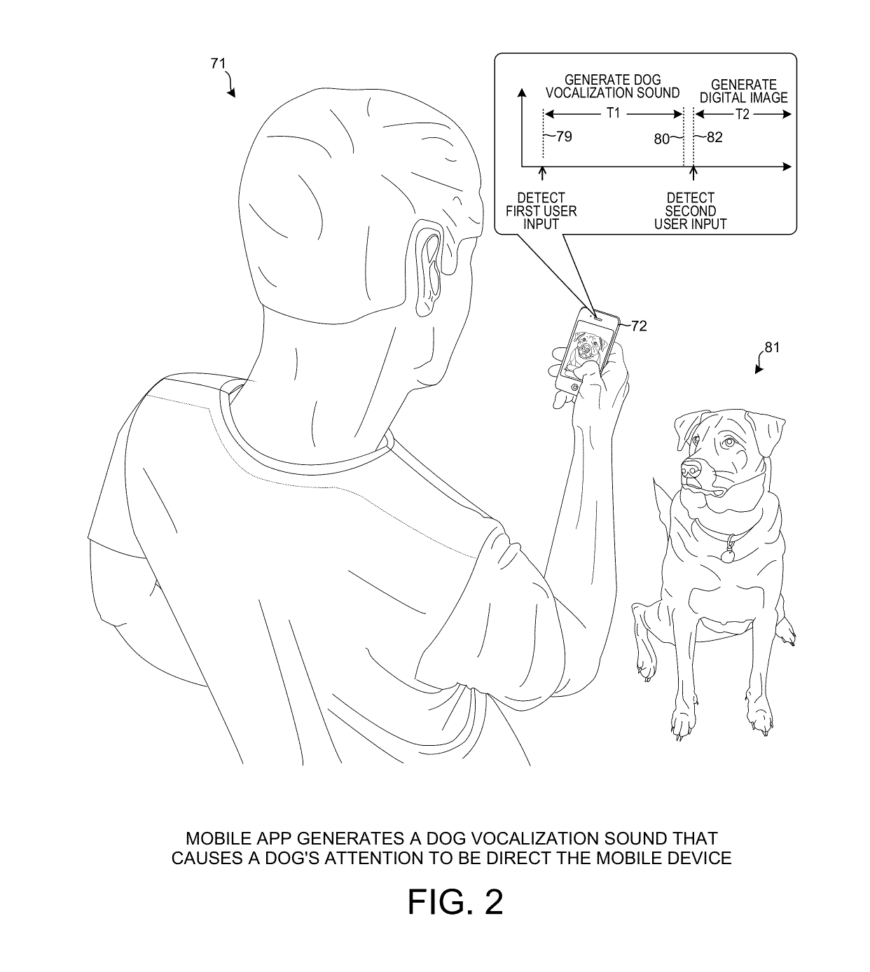

In a sixth step (step 56), in response to the button press of the fifth step, the mobile app causes the wireless mobile communication device to generate a dog vocalization sound (for example, a dog whimper or a dog bark) by playing a digital audio file. For example, in FIG. 2, after the user presses the “MAKE WHIMPER SOUND!” button 77, the mobile app generates a dog vocalization sound. Reference numeral 79 identifies when the mobile app initiates the generation of the dog vocalization sound. Reference numeral 80 identifies an end of the generation of the dog vocalization sound. The dog vocalization sound is generated for a time period T1. The generation of the dog vocalization sound is a result of playing of a digital audio file. The dog vocalization sound is preferably a dog whimper. The duration of the dog whimper is one second+/−two-tenths of a second, but is at least half of one second (>1.0 sec). The dog whimper has a strongest tone having a frequency that is at least five hundred hertz and at most thirty-four hundred hertz (500-3,400 Hz). In another example, the dog vocalization sound is a dog bark. The duration of the bark less than half of one second (<0.5 sec). The dog bark has a strongest tone having a frequency that is at least two hundred hertz and at most six-thousand hertz (200-6,000 Hz).

In a seventh step (step 57), in response to the dog vocalization sound emanating from the wireless mobile communication device, a dog looks in the direction of the wireless mobile communication device in an attempt to locate the origin of the dog vocalization sound. For example, in the example of FIG. 2, dog 81 looks in the direction of the iPhone 72 in an attempt to locate the origin of the dog vocalization sound.

In an eighth step (step 58), the user presses the “TAKE PICTURE” button with the dog's face showing in the unshaded inverted triangle. For example, in FIG. 4, the user 71 presses the “TAKE PHOTO!” button 78 when the dog's face is showing in the unshaded inverted triangle 75 displayed on the screen of the wireless mobile communication device.

In a ninth step (step 59), in response to the button press, the mobile communication device captures a digital image of the dog's face. For example, in FIG. 2, the iPhone 72 captures a digital image of the face of dog 81. Reference numeral 82 identifies when the mobile app detects the pressing of the “TAKE PHOTO!” button 78 and begins capturing the digital image. The resulting digital image of dog 81 is captured during time period T2.

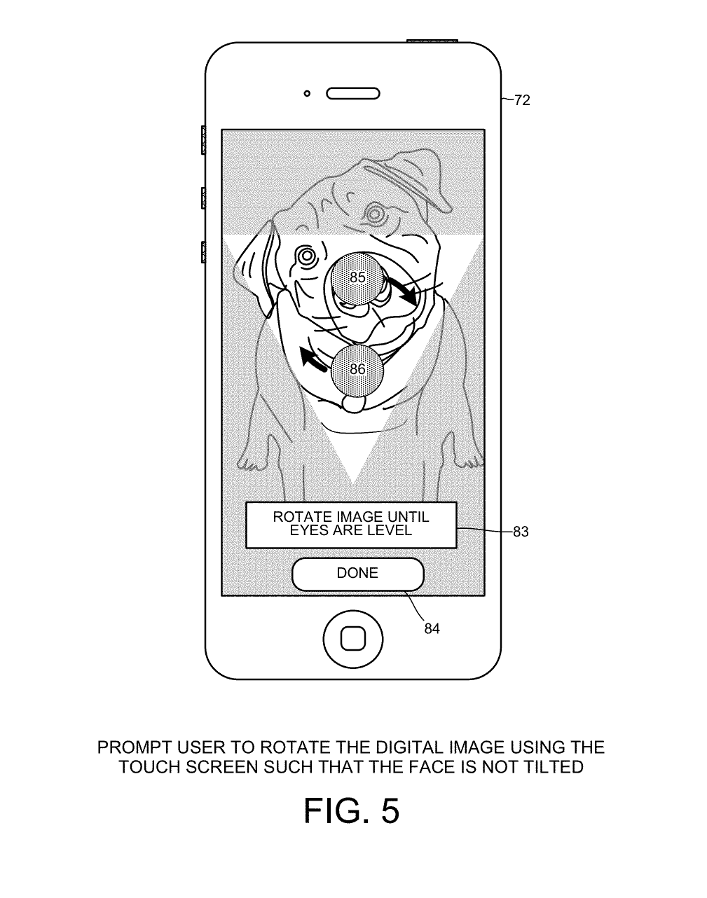

In a tenth step (step 60), the mobile app causes a “ROTATE PICTURE UNTIL THE EYES ARE LEVEL” message to appear on the screen, along with a “DONE” button. For example, in FIG. 5, the mobile app renders a “ROTATE IMAGE UNTIL EYES ARE LEVEL” button 83 and a “DONE” button 84 on the touch screen display of the iPhone 72.

In an eleventh step (step 61), the user uses the touch screen to rotate the image as necessary, and then presses the “DONE” button. In FIG. 5, the user 71 performs a two-finger press and rotate motion on the touch screen of the iPhone 72 to rotate the image of the dog 81. Reference numerals 85 and 86 represent the user generated touch event causing the digital image to rotate. After having rotated the image appropriately, the user 71 presses the “DONE” button 84.

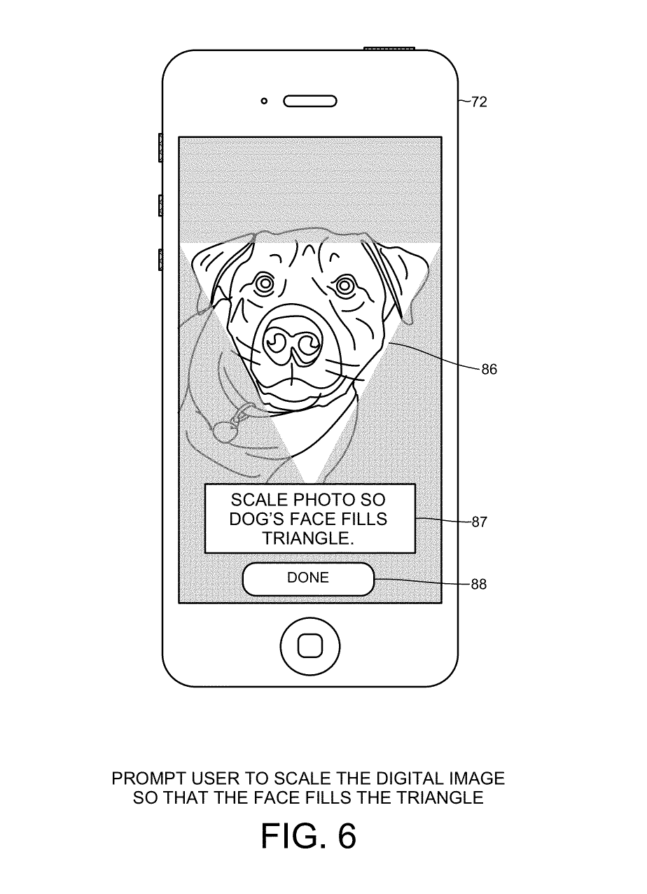

In a twelfth step (step 62), the mobile app causes an “EXPAND OR SHRINK THE IMAGE TO FIT THIS TRIANGLE” message to appear, along with a “DONE” button. In FIG. 6, the mobile app renders a “SCALE PHOTO SO DOG'S FACE FILLS TRIANGLE” message 87 and a “DONE” button 88 on the display of the iPhone 72.

In a thirteenth step (step 63), the user uses the touch screen to scale the image to fit the inverted shaded triangle, and then presses the “done” button. In FIG. 6, the user presses “DONE” button 88.

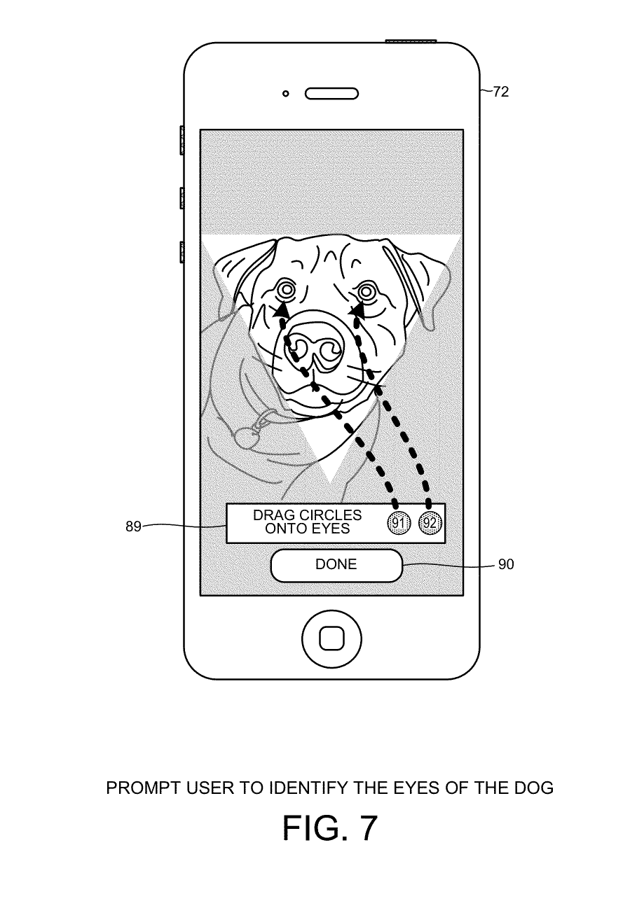

In a fourteenth step (step 64), the mobile app causes a “DRAG CIRCLES ONTO EYES” message to appear on the screen, along with two circle symbols, and along with a “DONE” button. The message is an instruction to identify the eyes in the digital image of the dog. In the specific example of FIG. 7, the mobile app renders a “DRAG CIRCLE ONTO EYES” message 89 and a “DONE” button 90 on the display of the iPhone 72. Reference numerals 91 and 92 identify the circle symbols to be dragged via the touch screen of the iPhone 72 by the user 71 onto the eyes of the dog.

In a fifteenth step (step 65), the user uses the touch screen to drag the circle symbols onto the eyes of the image of the dog, and presses the “done” button. In FIG. 7, the user 71 presses the “DONE” button 90 after identifying the dog's eyes.

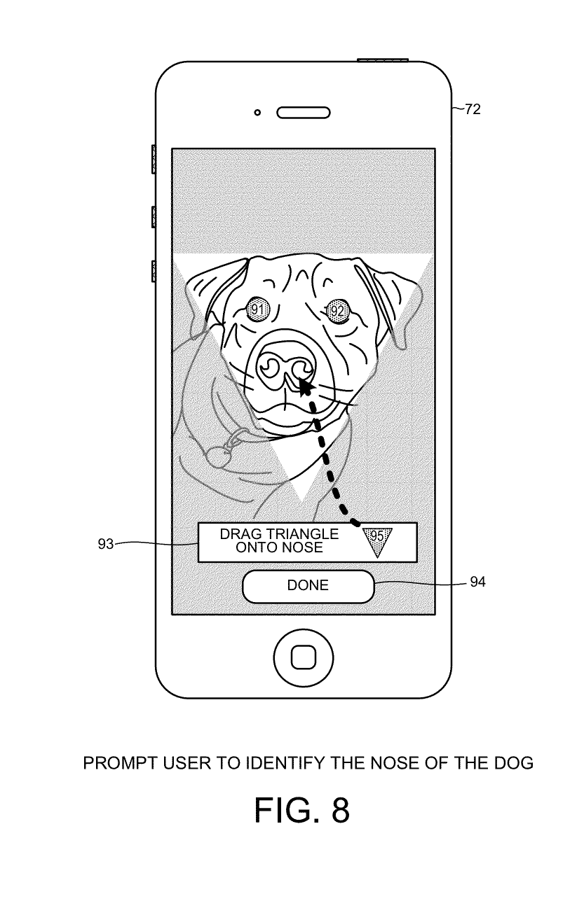

In a sixteenth step (step 66), the mobile app causes a “DRAG TRIANGLE ONTO THE NOSE” message to appear on the screen, along with a triangle symbol, and along with a “DONE” button. The message is an instruction to identify the nose in the digital image of the dog. In the specific example of FIG. 8, the mobile app renders a “DRAG CIRCLE ONTO EYES” message 93 and a “DONE” button 94 on the display of the iPhone 72. Reference numeral 95 identifies a triangle symbol to be dragged via the touch screen of the iPhone 72 by the user 71 onto the nose of the dog.

In a seventh step (67), the user uses the touch screen to drag the triangle symbol onto the nose of the image of the dog, and presses the “done” button. In FIG. 7, the user 71 presses the “DONE” button 94 after identifying the dog's nose.

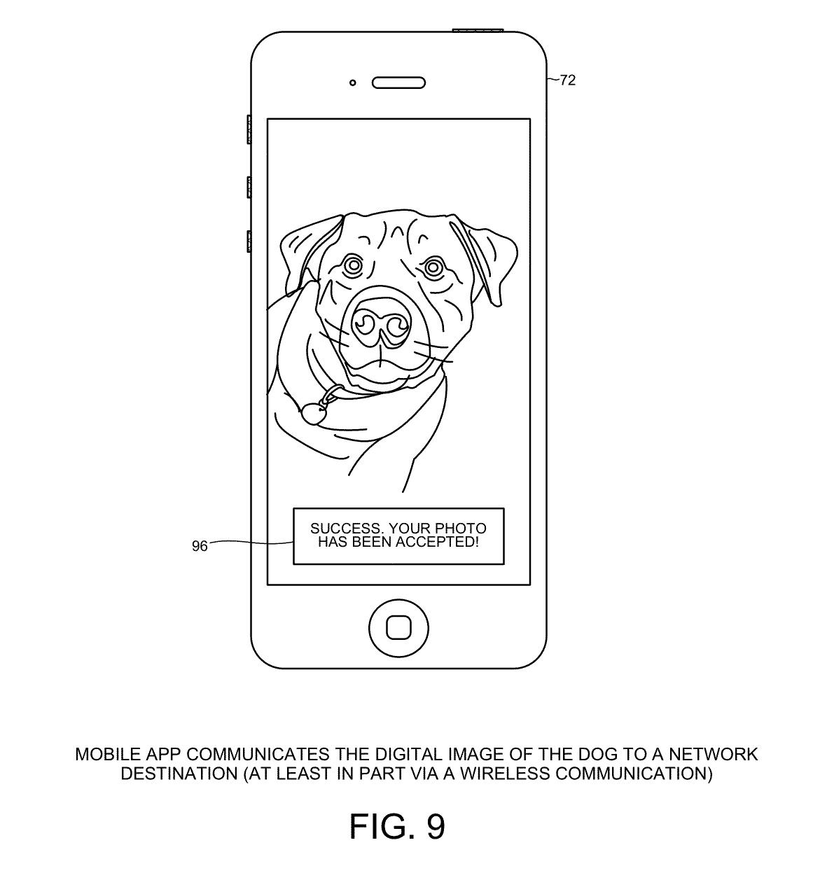

In an eighteenth step (68), the mobile app determines whether the captured digital image of the dog is acceptable for the Finding Rover “FR” system facial recognition to use in performing further facial recognition process steps. In the illustrated example, the determination is that the image is acceptable. Accordingly, as shown in FIG. 9, the mobile app causes a “SUCCESS. YOUR PHOTO HAS BEEN ACCEPTED!” message 96 to be appear on the screen of the iPhone 72.

In a nineteenth step (69), the captured digital image of the dog is then used in further facial recognition processing on the FR system. In one example, the digital image and/or information from the digital image is then automatically communicated across the internet to a server upon which the FR system facial recognition software is operating. The appropriate FR system code executing on the server receives the digital image and associated information due to the mobile app sending the communication to a network destination address (for example, network socket given by a TCP destination port and IP destination address) known to the mobile app. Further details on how the digital image of the dog is used in further facial recognition processing on the FR system is described in further detail below, and is set forth in: 1) U.S. patent application Ser. No. 13/610,877, entitled “Facial Recognition Lost Pet Identifying System”, filed on Sep. 12, 2012, and 2) provisional U.S. Patent Application Ser. No. 61/565,962, entitled “Facial Recognition Lost Pet Identifying System”, filed Dec. 1, 2011 (the entire subject matter of Ser. No. 13/610,877 and 61/565,962 are expressly incorporated herein by reference). Although an example is set forth above where a user uses a wireless mobile communication device to carry out the method 50, in other examples another type of electronic device or devices may also be used to make the dog vocalization sound and to capture a suitable digital image of a dog.

### Exemplary FR System Using the Mobile App

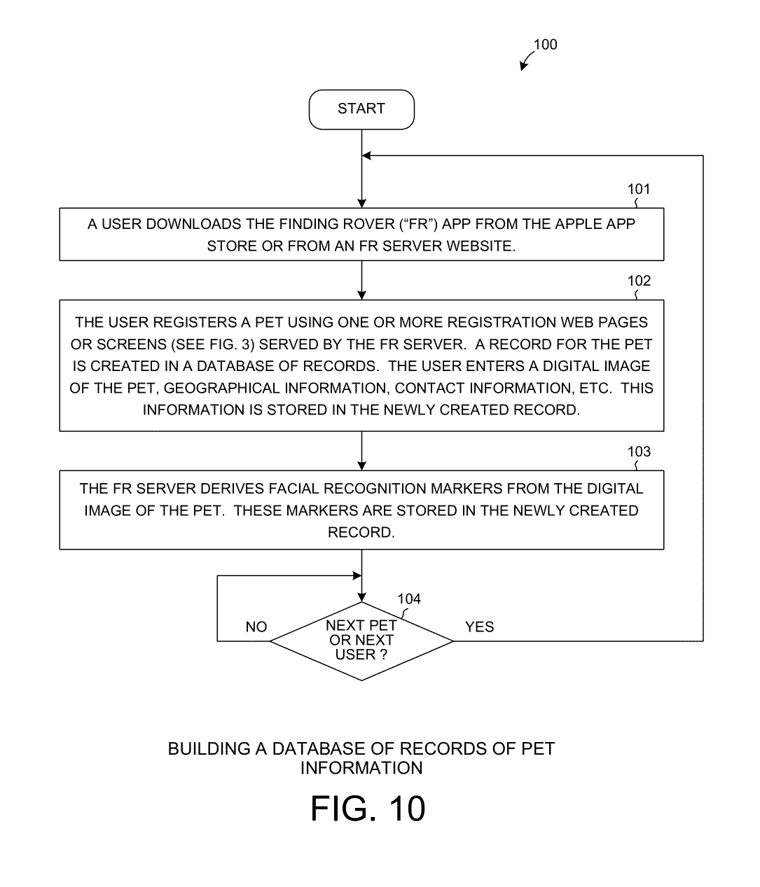

FIG. 10 is a flowchart of a method 100 of using a system (called the “Finding Rover” system, hereinafter the “FR system”) to build a database of records of pet information. In a first step (step 101), a user uses a wireless mobile communication device to download a mobile application referred to here as the “FR app”. In one example, the mobile application is a so-called “mobile app” for execution on a cellular telephone such as an iPhone available from Apple Computer of Cupertino, Calif. In the specific example described below, the user's wireless mobile communication device is an iPhone. Using the iPhone, the user accesses an internet repository of mobile apps. In the present example involving the iPhone, the user uses the iPhone to access the Apple App Store website via the internet. Alternatively, the mobile app may be downloaded from the FR server system of the FR system. An icon of the FR app is displayed on the touch screen of the iPhone. The user then selects the FR app icon using the touchscreen of the iPhone. As a result, the FR app is downloaded from the Apple App Store or from the FR server system into the user's iPhone cellular telephone via the internet. Established and well-known procedures for supplying apps to users of iPhones are used.

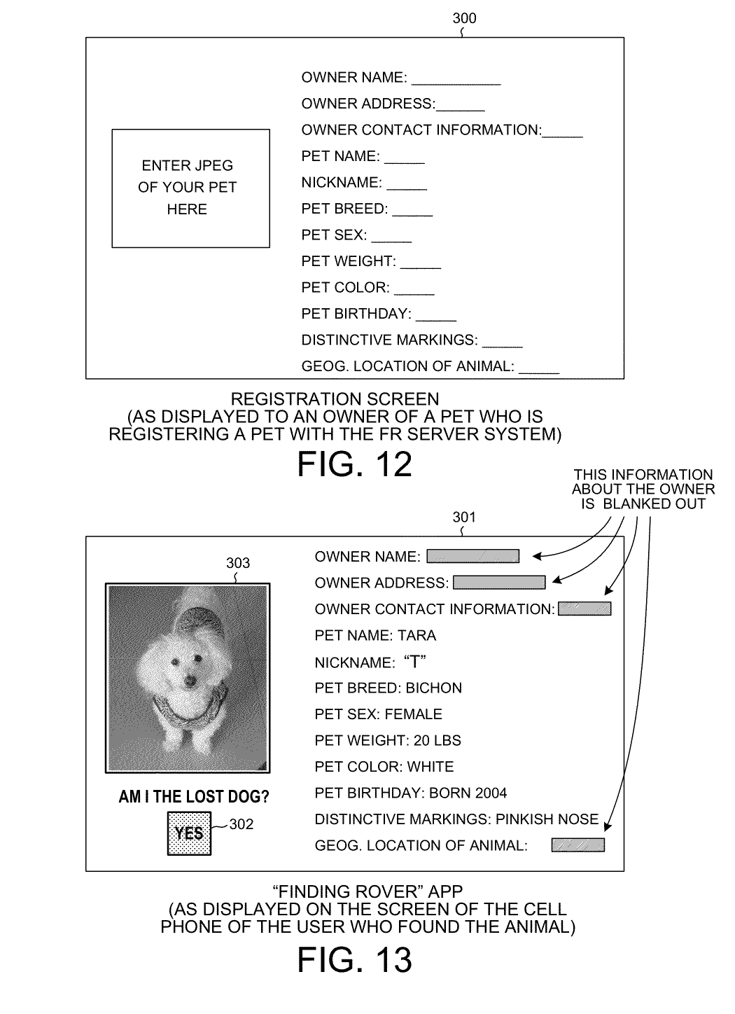

Next (step 102), the user registers a pet (i.e., an animal) using one or more registration web pages served by the FR server system or using the FR mobile app with web data provided by the FR server system. The FR server system is operated by a pet finding entity. The registration screens (whether web pages or mobile app screens) are displayed to the user. FIG. 12 is a diagram of an example of a registration screen 300 as the registration screen is seen on the screen of the user's iPhone.

In response to prompts on the registration screens, the user enters information (step 102) such as the user's name, the user's address, contact information for the owner of the pet (for example, an email address and/or a telephone number), the name of the pet, the breed of the pet, the sex of the pet, the weight of the pet, the color of pelt of the pet, the age or birthday of the pet, distinctive markings on the pet, the geographical location where the pet lives, and other identifying information about the pet and about the owner of the pet. In addition, the user is prompted by the registration screens to upload one or more digital photographs (for example, JPEG files) of the pet to the FR server system. The user complies. In one example, the FR app prompts the user to use the camera functionality of the iPhone to take a digital image of the owner's pet, and the resulting digital image file is then automatically communicated to the FR server system. See FIGS. 1-9 above and the associated textual description for further details of how the iPhone is used (in one specific example) to take a digital photograph of a pet dog. As a result of entering the information and providing the digital photograph or photographs of the pet, a new record associated with the pet being registered is created in an FR database on the FR server system, and all the collected information is stored in this record on the FR server system.

The FR database preferably contains many such records, where each record is for a different pet, and where each record includes: 1) identifying information about the pet, 2) one or more digital images of the pet, and 3) information about the owner of the pet.

The FR server system uses a computer-implemented facial recognition process to analyze the digital image (step 103) of the pet and to derive from the digital image a set of facial recognition markers that are indicative of the pet. In one example, the facial recognition markers for a pet are in the form of a byte string. The byte string has an associated identifier (ID). The ID is usable to identify the record in the FR database. The byte string of derived markers is stored in the record along with the ID and other identifying information about the pet and about the pet owner. At the conclusion of the registration process, the FR app is left installed on the user's cellular telephone and a record for the user's pet is present in the database on the FR server system.

This process is repeated (step 104) so that the FR database on the FR server system includes records for many pets. Although an example is described above where a cellular telephone is used as the vehicle for entering information into the FR server system to build a record for the pet, in other examples the user may use another internet-connected device such as a personal computer to register a pet. Although an example is described above where the person who performs the registration process and registers a pet is the pet's owner, in other examples a person or entity other than the owner performs the registration process and registers the pet. For example, an owner's pet may be registered by a veterinarian or an employee of the veterinarian. This registration may occur when the pet is present at the veterinarian's office or is otherwise being processed by the veterinarian's office. An owner's pet may also be registered by a retail store owner or an employee of a retail store. An owner's pet may be registered at an animal shelter by an employee or other worker at the shelter. All the user registration information solicited by screen 300 of FIG. 12 need not be entered.

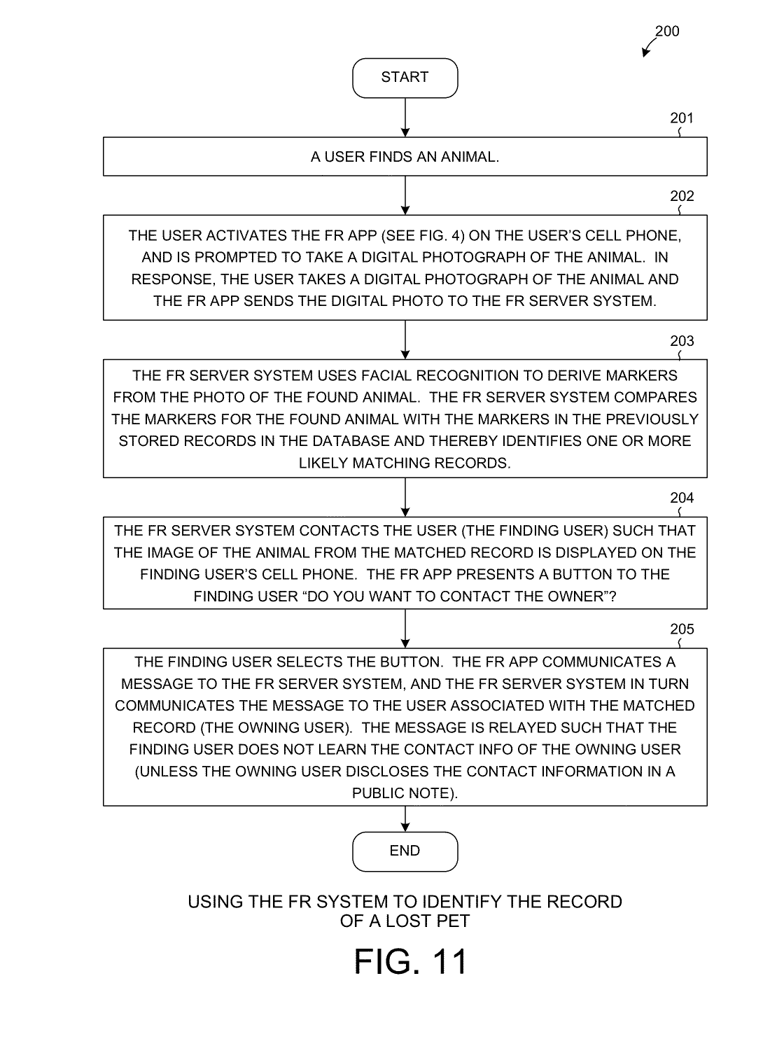

FIG. 11 is a flowchart of a method 200 of using the FR system to identify a lost pet and to contact the owner of the lost pet. In the illustrated example, a finding user of the FR system finds an animal that appears to be a lost pet (step 201). (This animal that was apparently lost, and is then found by the finding user, is sometimes referred to as the lost animal and is sometimes referred to as the found animal in the description below.)

The user activates (step 202) the FR app on the user's cellular telephone and is prompted by the FR app to use the finder's cellular telephone to take a digital photograph (also referred to here as a “digital image”) of the animal. In response, the user takes the requested digital photograph using the cellular telephone. The user may also be prompted by the FR app to identify the left eye, right eye, and the nose. The user may then be prompted to enter other apparent identifying information about the animal such as the animal's breed, weight, size, color, apparent age, distinctive markings, etc. The FR app then causes the digital image of the found animal along with the other collected information to be sent by wireless communication from the finder's cellular telephone to the FR server system. The wireless communication is not a voice call or email communication, but rather is an automatic TCP/IP data communication that does not involve person-to-person communication. The FR app may also communicate geographical location information indicative of the location where the animal was found. For the example, the FR app may cause GPS information indicative of the location of the cellular telephone to be automatically communicated along with the digital image to the FR server system. If the finder's cellular telephone does not have a GPS capability, then the user may be prompted to enter geographical location information (for example, cross street) manually indicating where the animal was found or where to animal is located.

Next, the FR server system uses a computer-implemented facial recognition process (step 203) to derive facial recognition markers from the digital image of the found animal. In one example, the very same computer-implemented facial recognition process used in the registration process to generate a byte string from the digital image submitted during registration is used so that a byte string is generated from the digital image submitted in step 202. The byte string generated from the digital image submitted in step 202 may have the same number of bytes as does each of the other bytes strings stored in the database on the FR server system. The FR server system then compares the derived markers for the found animal (and the other collected information about the found animal including where the animal was found) to markers and other information stored in other records in the database. This comparing/searching step is described in further detail below. There are several different suitable ways this comparing/searching step can be carried out. As a result of this comparison of markers, one or more records from the database are identified. These identified records are the records whose markers and other information are the best matches for the markers and other information of the found animal.

In one example, records for pets that are indicated by the FR database to be resident (as determined by information in their respective records) within a certain radius of the geographical location where the animal was reported found are compared/searched first. In one example, the geographical location information received in step 202 along with the digital image is used to select a subset of the records in the database, where the location information in each subset record indicates the pet is resident within the certain predetermined radius of the geographical location of the mobile communication device used to take the digital image of the found animal. The amount of time required to perform the comparing/searching step is reduced by reducing the number records that are compared/searched.

Once the FR server system has identified one or more likely matching records, the FR server system then forwards certain information from the identified records (step 204) to the cellular telephone of the user who found the animal. In one example, a digital photograph of the pet from each of the identified likely matches is displayed on the display of the finding user's cellular telephone. For each such digital photograph, a user-selectable button is also displayed on the touchscreen of the cellular telephone along with a query. The query asks the finding user to confirm that the animal the user has found is the animal in the digital photograph. In one example, this query is presented in the form of a button on the touchscreen of the finding user's iPhone. In one example, the FR system is provisioned such that less than ten seconds elapse between the time when the finding user causes the photograph of the found animal to be sent from the finding user's iPhone to the FR system and the time when the photographs of likely matches are displayed to the finding user on the screen of the finding user's iPhone.

In one example, if the finding user selects the button by a picture of an animal, then the finding user is confirming both: 1) that the animal in the corresponding picture is the found animal, and 2) that the finding user wants the registered owner of the displayed animal to be contacted. FIG. 13 is a diagram of information 301 displayed on the display of the cellular telephone of the finding user in one example. As indicated in FIG. 13, certain sensitive information about the identity of the owner of the registered pet is, however, not made available to the finding user. Which information is made available to the finding user, and which information is not made available to the finding user, is specified by the owner user in the earlier registration process. Button 302 displayed on the screen of FIG. 13 is a button (selectable key) that the finding user can select (by pressing) to indicate that the animal in picture 303 is the same animal that the user found. For each such likely-match photograph presented to the finding user, there is a similar button.

If the finding user believes that the found animal is the animal in picture 303, then the finding user selects the associated button 302. As a result, in one example, the FR app executing on the finding user's cellular telephone causes a message to be sent in the form of a TCP/IP wireless communication (step 205) from the finding user's cellular telephone to the FR server system. This in turn causes the FR server system to send a message from the FR server system to the owner of the displayed animal using the contact information stored in the identified record. In one example, the message is sent such that the finding user does not learn the contact information of the owner of the displayed animal. The FR server system may contact the owner by email, by a push notification to the owner's cellular telephone, by a simulated voice call to the user's cellular telephone, or by another mechanism as previously indicated by the owner in the registration process. In another example, if the registered owner has indicated in the registration process that the owner's contact information may be displayed to a finding user, then the owner user's contact information is displayed to the finding user thereby enabling the finding user to contact the owner user directly. Once the finding user and the owner user are in communication with one another, the two users can determine what action to take next.

As indicated above, in some examples the finding user is presented with not just one digital image of the animal that best matches the digital image of the found animal but rather is presented with digital images of several animals that the FR server system determines might be the found animal, and these several digital images are presented to the user in a ranked order in terms of how close the FR server system believes the matches to be. The finding user can then scroll through or flip through the ordered list of potential match images, and if a pictured animal appears to the finding user to be the animal the finding user found, then the finding user may select the button associated with the appropriate pictured animal. Selection of the button confirms that the animal in the digital image of the potential match record is the animal that the finding user found, and that the animals in the other digital images of the other potential match records are more likely not the found animal.

Although an example is described above in which a pet is registered by its owner with the FR system, and then the pet is lost, and then a finding user uses the FR system to reunite the lost pet with its owner, in other usage examples a pet is lost, and then a finding user registers the pet with the FR system as being lost, and thereafter the owner uses the FR system for the first time and locates the lost pet. In this scenario, the finder registers the animal as a lost animal and enters a digital image of the lost animal. The finder may be a previous FR system user at the time the finder found the animal, or the finder may never have previously used the FR system at the time the finder found the lost pet. From the digital image submitted by the finder, the FR system generates a byte string of markers and the byte string is then stored in the database as part of a record. The record includes a flag indicating that the record is for a lost animal. When the owner later seeks to use the FR system, the owner is prompted to go through the registration process. When the owner submits a digital image as part of the registration process and a byte string of facial recognition markers is generated, the FR system performs a compare/search of the byte string for the owner-submitted digital image with byte strings for records having lost animal flags. The FR system then displays to the registering owner digital photographs from likely-match records whose animal lost flags are set. The owner who has lost the animal can then look through the pictures of likely-match lost animals and hopefully identify the lost animal there. Accordingly, a finding user can post a digital image of a lost animal first, and thereafter a previously unregistered owner can register and then be put in touch with the finding user who posted the digital image.

Although examples are described above where computer-implemented facial recognition is used to reunite a lost pet with its owner, the FR system need not employ computer-implemented facial recognition in all embodiments for all purposes. In some embodiments, the FR system determines likely match records using information without the use of automatic computer-implemented facial recognition, and the best likely matches are presented to a user looking for a lost animal in the form of a set of digital images. As in the case of the computer-implemented facial recognition examples described above, each likely match digital image is displayed to the user along with an associated button. The user looking for the lost pet scrolls through these digital images of likely matches. By human visual inspection, the user determines whether the animal in a picture is the lost pet. If the user determines that the animal in a picture is the lost pet, then the user can then select the button associated with the picture. If the user is the animal owner, then the user can use information about the finding user stored in the record to communicate with the finding user. If the user is the finding user, then the user can use information stored in the record about the owner to communicate with the owner user. The FR system website provides a registered user with an ability to enter Boolean equations of multiple database searching parameters, so that the FR system will then evaluate the expression of searching parameters against information stored in the records and will return information from the identified records. The computer-implemented facial recognition is but one mechanism for searching through the records of the database.

Utilizing GPS technology in conjunction with facial recognition markers is unique to the FR system. The combination creates an identification system with peerless accuracy in identifying lost/found pets. GPS tethering to an animal's location via its owner's mobile phone when away and to its main address when home makes the FR system significantly more effective in quickly locating lost pets regardless of whether the pet and owner are on vacation, or at the park, or at home. Whereas there are several unique challenges to animal image identification, the FR system involves a multi-layer image processing program that ensures that the most accurate facial mapping occurs regardless of camera angle or lighting conditions. To account for photos taken of a stray animal, a loose pet or a pet that simply will not cooperate with putting its face in the perfect depth and centered position for taking a digital photograph of the animal, a first layer of the FR image processing system shears, rotates, shifts and renders the inputted photo to align the eyes and nose to the correct axis and depth for carrying out facial recognition. Fur color, markings and color patterns are unique to animal image recognition. However, lighting conditions can result in an animal's coloration looking dramatically different from image to image. To eliminate this disparity, a second layer of the FR image processing system identifies lighting type, saturation, hue and balance in each inputted photo and then re-colorizes each image to have same lighting type. The reprocessed images that have been processed through the first and second layers are then used for facial recognition mapping. In each record, in addition to one such preprocessed image, there is a low resolution version of the image that is also stored in association with the facial algorithm keys for future image comparison purposes.

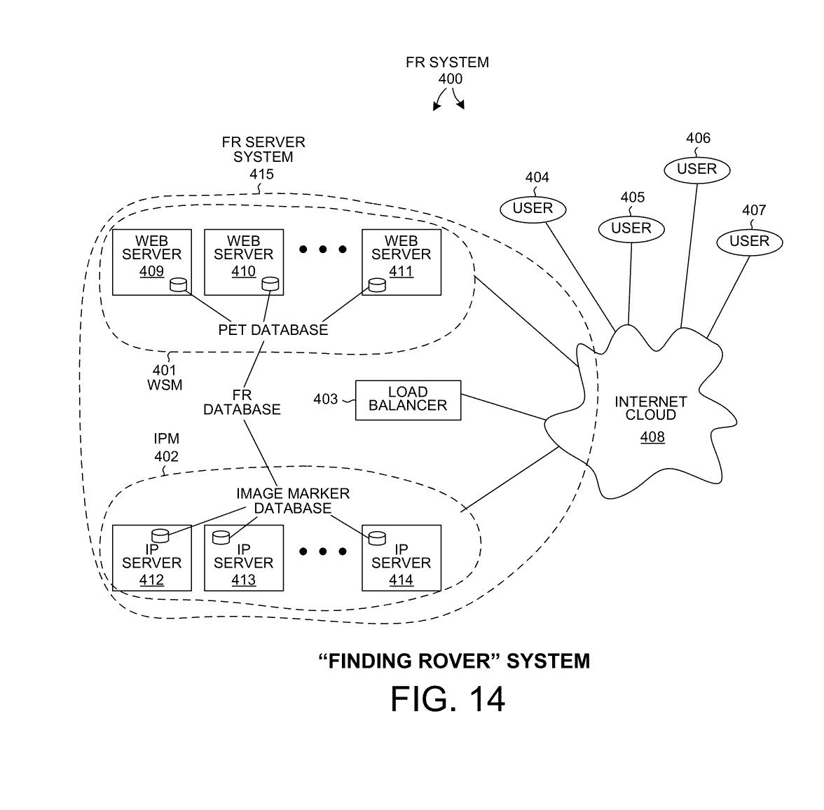

FIG. 14 is a diagram of one embodiment of the FR system 400. FR system 400 includes the FR server system 415 and the web-enabled devices of users 404-407. FR server system 415 in turn includes a web service mechanism (WSM) 401, an image processing server mechanism (IPM) 402, and a load balancer 403. A copy of a pet database is stored on each web server, and the copies of the pet database are synchronized. In addition, a copy of an image marker database is stored on each IP server, and the copies of the image marker database are also synchronized. The pet database and the image marker database are referred to together here as the “FR database”.

WSM 401 serves the FR website web pages and web data to the web-enabled devices of users 404-407 and provides interactive communication capabilities with the users 404-407 via networks 408. Networks 408 are represented in the diagram by the internet cloud. A user can communicate with and interact with WSM 401 using any internet connected device that has a suitable web browser. A user can use a web-enabled wireless mobile communication device such as a cellular telephone, or a hardwired landline connected desktop computer having a web browser.

In one implementation, WSM 401 actually includes a plurality of distributed cloud-based web servers 409-411. IPM 402 does not interact directly with users, but rather performs directed sub-functions for WSM 401. Communication between WSM 401 and IPM 402 is via TCP/IP data communications across the internet 408. In one implementation, IPM 402 actually includes a plurality of distributed cloud-based servers 412-414. The load balancer 403 balances requests coming in from the users 404-407 to selected ones of the web servers 409-411. The load balancer 403 also directs function requests from the web servers 409-411 of WSM 401 to selected ones of the IP servers 412-414 of IPM 402 so that the computational loads from the requesting WSM 401 are distributed across the various servers 412-414 of IPM 402.

Each of the web servers 409-411 is, in one example, an Intel-based server running a Microsoft Windows OS, upon which an IIS (Internet Information Services) web server application software runs in a Microsoft.NET framework. Each of the IP servers 412-114 is, in one example, an Intel-based server running a Microsoft Windows OS, upon which MySQL database software runs in a Microsoft.NET framework. The load balancer is, in one example, a F5 load balancer. Although an example is set forth here in which FR server system 415 includes WSM 401, IPM 402, and load balancer 403, in other examples both the web server and the IP server functionality is performed by a same single server.

In carrying out a first function, IPM 402 receives a digital image from a web server of WSM 401 via the internet 408 and converts the digital image into a byte string of facial recognition markers as described above. The IPM 402 then stores the byte string in an associated record in the image marker database. The record is identified by a unique ID. In carrying out a second function, IPM 402 receives a digital image of a found animal and a plurality of IDs from a web server of WSM 401 via the internet 408, where the IDs identify records in the image marker database to be searched. IPM 402 compares/searches the byte strings of the records identified by the IDs for the best match to the image of the found animal, and returns to the requesting web server of the WSM 401 an ordered list of likely match IDs. In one embodiment, both WSM 401 and IPM 402 store, or have access to, a mirrored copy of the entire FR database of records. Each record in the FR database is identified by its corresponding ID.

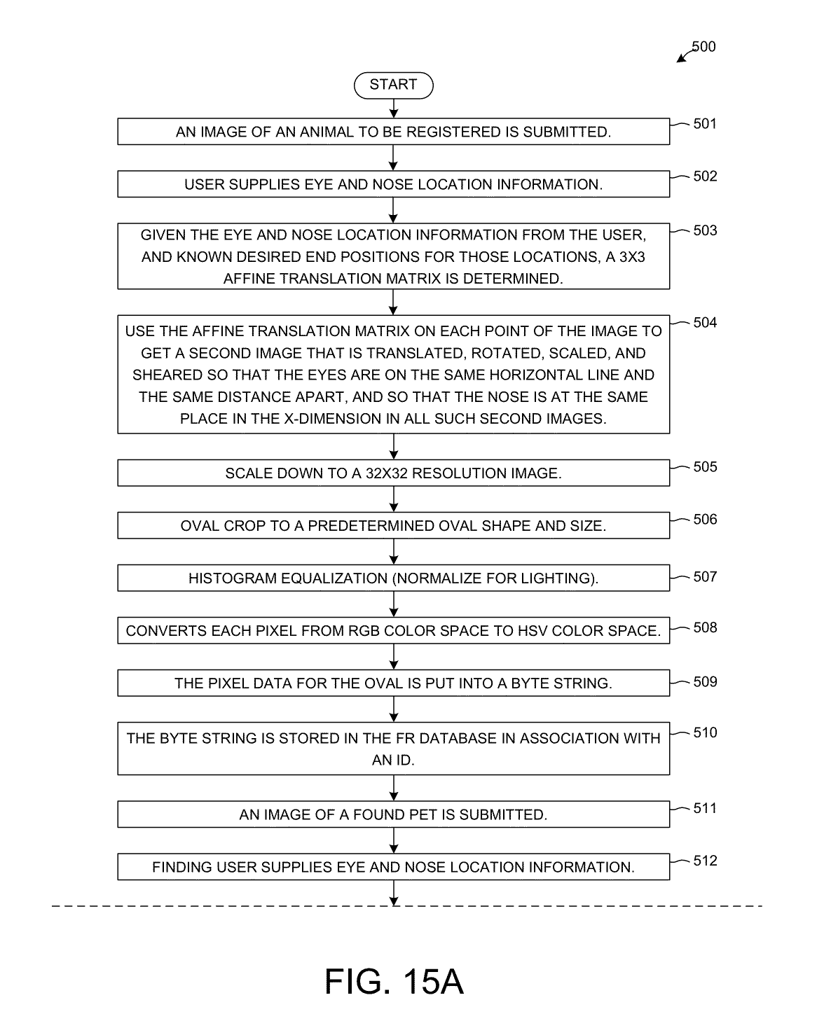

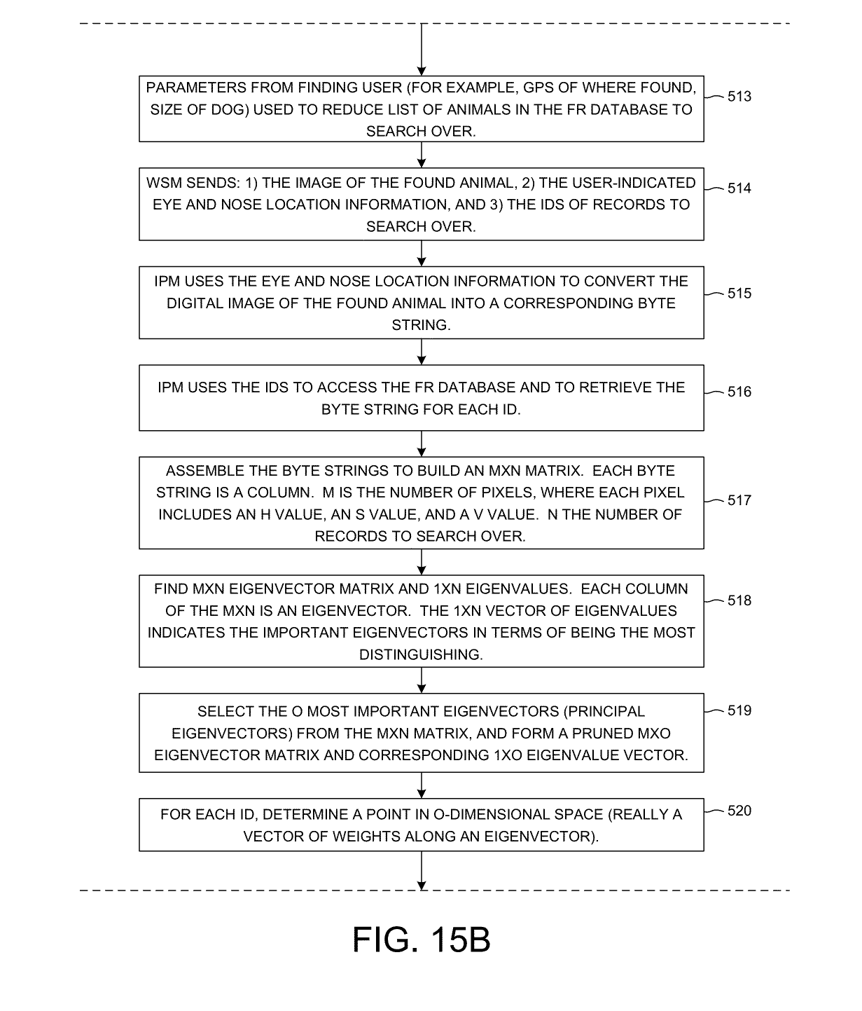

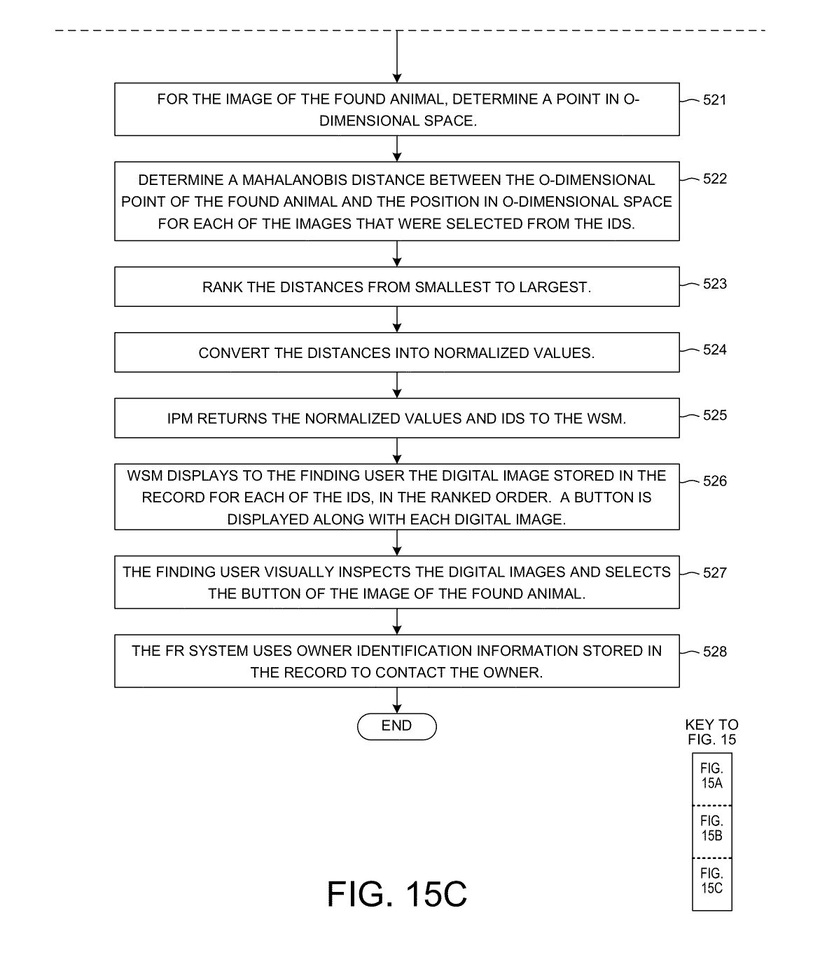

FIG. 15 is a flowchart that illustrates an exemplary operational flow through a method 500 carried out by FR system 400. When an image is submitted (step 501) to the FR system, whether the image is being submitted as part of the registration process or is being submitted as a picture of a found animal, the user submitting the image is requested by WSM 401 to indicate where the eyes are located in the image and where nose is located. In one example, an instruction to place the user's screen cursor on the left eye is displayed to the user and then an instruction to press enter or to press a button on the user's mouse is displayed. The user complies and presses enter or the button. In this way a user who owns an animal supplies (step 502) user-indicated left eye location information to WSM 401. WSM 401 serves the web pages or web data that lead the user through the registration process. Likewise, instructions are displayed to the user to put the cursor on the right eye of the animal and then to press enter or to press on a button on the user's mouse. Likewise, instructions are displayed to the user to put the cursor on the nose of the animal and then to press enter or to press on a button on the user's mouse. The user therefore supplies user-indicated left eye location information, user-indicated right eye location information, and user-indicated nose location information to WSM 401.

The digital image of the animal to be registered, along with user-indicated left eye location information, user-indicated right eye location information and user-indicated nose location information is communicated from WSM 401 to IPM 402. Given the left and right eye locations and the nose location given by the user, and given desired end positions for those locations in a transformed image, IPM 402 determines a 3×3 affine transformation matrix (step 503). IPM 402 uses the determined 3×3 affine transform matrix to translate, rotate, shear, and scale (step 504) the originally submitted digital image so that the nose in the transformed image is centered in the horizontal axis, and so that the eyes in the transformed image are disposed on the same horizontal line, and so that the distance between the eyes in the transformed image is a predetermined distance. The resulting transformed image is then scaled down (step 505) to be a 32×32 pixel image. In one novel aspect, the 32×32 pixel image is then cropped to have an elliptical oval shape (step 506) where the resulting oval-cropped image contains pixels for the eyes and nose. In one example, the width-to-height ratio of the elliptical oval shape is 3/2.5. Histogram equalization is then performed (step 507) to normalize for the original digital images being taken under different lighting conditions. The equalized elliptical oval image is then converted from the RGB color space into the HSV (hue, saturation, value) color space (step 508). Each pixel is represented by three values: one H value, one S value, and one V values. The pixel values of the various rows of pixels making up the elliptical oval image are then put into a linear sequence (step 509). The linear sequence is referred to here as a “byte string”. In one example, for any digital image of an animal submitted, the byte string created has the same number of bytes. A digital identifier (ID) is assigned to the byte string for identification purposes, and the byte string is stored (step 510) in a record in the FR database under the ID. All other information collected about the animal and about the owner is also stored in the record, including, for example: 1) the original digital image of the animal to be registered, 2) the breed, color, sex, age, weight, and distinctive markings of the animal to be registered, 3) contact information for the owner, 4) geographical location information indicating the residence of the animal to be registered, 5) veterinarian identification and contact information, 6) veterinarian information including notice scheduling information.

In the specific example of FIG. 15, another user then finds the animal. The finding user uses the FR mobile app executing on his/her wireless communication device to access the WSM-served web services. The finding user is prompted by WSM-served screens to go through the same image submission process as in the registration example described above. The finding user is prompted to take a digital image (step 511) of the found animal, and then is prompted to identify (step 512) the left eye location, the right eye location, and the nose location on the image. WSM 401 has access to a copy of the FR database. WSM 401 uses parameters received from the finding user to reduce the list of records in the FR database to search over. In one example, Global Positioning System (GPS) geographical location information from the finding user's wireless communication device indicates where the animal was found. This geographical location information is received from the finding user and is used by WSM 401 to identify in the FR database those records (step 513) where the animal's residence is within a certain predetermined distance of the geographical location where the animal was found. In some embodiments, other animal identifying information from the finding user is also used to limit the number of records to be searched. WSM 401 then supplies IPM 402 the IDs of this limited number of records, along with the digital image of the found animal, and along with the user-indicated eye and nose location information for the image of the found animal (step 514). IPM 402 uses the user-indicated eye and nose location information to process and to convert the digital image of the found animal into a corresponding byte string (step 515) by the same process described above.

IPM 402 uses the IDs supplied by WSM 401 to access the associated records in the FR database and to retrieve the byte string for each ID (step 516). The retrieved byte strings are assembled to form an M×N matrix (step 517), where each M value column is one byte string. In the present example WSM 401 supplied N IDs to search over, so there are N byte strings, and so there are N columns in the matrix. Each of the M×N values includes one HSV triplet of values.

Next, IPM 402 performs a singular value decomposition on the M×N matrix, thereby generating an M×N matrix of eigenvectors and one 1×N eigenvalue vector (step 518). Each M value column of the M×N eigenvector matrix is one eigenvector. There are N eigenvectors. Each of the N values of the 1×N eigenvalue vector is one eigenvalue. The eigenvalues indicate the spatially important eigenvectors in the matrix.

Next, IPM 402 selects the O most important eigenvectors from the M×N eigenvector matrix, thereby forming a pruned M×O matrix (step 519). The value O in one representative example is twelve. Similarly, a corresponding 1×O eigenvalue vector is formed. Then, for each of the N IDs, a point in O-dimensional space is determined (step 520). The point in O-dimensional space is determined by multiplying the M×O matrix by the original byte string identified by an ID. This is done for each of the IDs, thereby generating a point in O-dimensional space for each of the N IDs. Likewise, a position in O-dimensional space is determined for the byte string of the image of the found animal (step 521). To do this, the M×O matrix is multiplied by the byte string of the image of the found animal.

Next, IPM 402 determines a Mahalanobis distance (step 522) between the position in O-dimensional space for the image of the found animal and the position in O-dimensional space for each of the N images that were selected from the IDs. The resulting N Mahalanobis distances are then ranked from smallest to largest (step 523). For each distance in the ranking, the associated ID is listed. The N distances and the N corresponding IDs may, for example, form a two column table, where the uppermost row corresponds to the smallest distance, where the next uppermost row corresponds to the next smallest distance, and so forth.

Next, IPM 402 converts the N distances into N normalized values (step 524). In one example, each distance is converted in a non-linear mapping into a percentage in a range of from zero percent to one hundred percent. The percentage value in a row indicates the likelihood that the image associated with the ID of the row is a match for the image of the found animal. IPM 402 returns to WSM 401 the normalized values and their associated IDs (step 525).

IPM 402 has therefore performed a function for WSM 401. WSM 401 supplied a function request to search records identified by IDs supplied by the WSM 401 and to indicate the best matches to a digital image supplied by WSM 401, using eye and nose location information also supplied by WSM 401. IPM 402 performed the function, and returned an ordered list of the IDs, where for each ID a percentage likelihood of the match being correct was supplied.

Next, by serving web data to the FR mobile application executing on the finding user's mobile communication device, WSM 401 displays to the finding user the digital image stored in the record for the highest percentage likelihood value along with a confirmation button, and then displays the digital image stored in the record for the next highest percentage likelihood value along with a confirmation button, and then displays the digital image stored in the record for the third highest percentage likelihood value along with a confirmation button, and so forth (step 526). The digital images displayed may be the low-resolution images stored in each record in the database. Next, the finding user visually inspects (step 527) the displayed images and selects the button for the image of the animal that the finding user found. As described above, the finding user's selection of the button may serve both as: 1) a confirmation that the animal of the digital image of the identified record is the same animal that the finding user found, and 2) an instruction to the RF system to initiate contact with the owner of the pictured animal. Next, in the example of FIG. 15, the FR system responds to the button selection by contacting the owner (step 528) using owner identification information stored in the matching record.

In one novel aspect, information in the FR database about an individual dog that was put into the FR database for lost pet locating purposes is thereafter used by the FR system to provide the registered dog owner with information particularly pertinent to the pet. For example, an owner of a registered pet can, in entering a retail store (for example, a pet store), use the mobile app on the owner's cellular telephone to indicate a desire to receive coupons or other information specific to the store. The FR system at this point knows, by virtue of receiving GPS information from the user's cellular telephone, that the user is physically present in the retail store. The FR system also knows information about the pet such as its breed and size and likely particular needs. The FR system therefore supplies to the owner, via the owner's cellular telephone, coupons usable at the particular store and for products that the owner is likely interested in due to the products being pertinent to owner's particular pet. The FR system may provide such electronic coupons usable in the particular retail store, or the FR system may provide information about sale prices or products available for purchase in the store.

My Treat Jar: A feature of the FR system referred to as “My Treat Jar” is usable by a user to register a desire to receive coupons and information only for particular products and services, where the particular products and services of interest are indicated by the user. Thereafter, the FR system may deposit into “My Treat Jar” of the user any electronic coupons, or electronic gift cards, or other information specific to those products and services. No unsolicited coupons or advertising or other contacts are put into a user's “My Treat Jar” if the treat jar has been set to exclude unsolicited content. The owner may indicate a desire to receive such targeted coupons and information without being bothered with unsolicited contact, by virtue of the owner using the mobile app and cellular telephone to register a desire to receive coupons and information at the time the owner enters the store using the owner's cellular telephone. Vendors of products and services also use the FR system to generate coupons, and if the setting of “My Treat Jar” indicates that such coupons are wanted by the particular user, then the RF system causes any such desired coupons to appear in the user's “My Treat Jar”. Information known by the FR system about the pet and the user's buying habits and the user's interests are also usable by the “My Treat Jar” function to select targeted coupons and other information that best matches the user's indicated desires. At the time the user enters a retail establishment, the GPS functionality of the user's mobile communication device may be used to alert the FR system, which in turn may automatically generate a targeted coupon (according to predetermined vendor agreements) for the user for items then known by the FR system to be available in the store, and the automatically generated coupon then appears in the user's “My Treat Jar”. Coupons and information in the “My Treat Jar” are ordered for viewing to show the coupons and information first that are specific to the GPS-determined location of the user. Accordingly, at the time a user enters a store, automatically generated coupons (for items in that store, and targeted to the individual user's indicated desires and interests) are generated and appear at the top of the list in the user's “My Treat Jar”.

In one novel aspect, veterinarians are enlisted and incentivized to register pets passing through their offices with the FR system. Veterinarians may find it onerous and/or expensive to send reminders and notices to pet owners. Reminders and notices may include reminders to bring a pet into the veterinarian's office to receive vaccinations, or to receive medications, or to receive other scheduled treatments and services. Reminders and notices may include reminders to a pet owner to give the pet certain medications. Reminders and notices may include advertisements for purchasing medications and other items and services at discount rates. In return for a veterinarian registering pets with the FR system, the FR system is made configurable by the veterinarian so that the FR system will thereafter automatically send out scheduled electronic notices for each registered pet to the owner. The veterinarian can specify, through a special veterinarian's portal having security features, what the notices will say and when the notices will be sent out.

Although the present invention has been described in connection with certain specific embodiments for instructional purposes, the present invention is not limited thereto. Rather than, or in addition to, a dog vocalization sound, a whistle sound or other dog attention grabbing sound can be employed in the image capture method of FIGS. 1-9. Accordingly, various modifications, adaptations, and combinations of various features of the described embodiments can be practiced without departing from the scope of the invention as set forth in the claims.

What is claimed is:

1. A mobile application (mobile app) for execution on a wireless mobile communication device, the mobile app comprising processor-executable instructions for:
(a) detecting user input on the wireless mobile communication device, wherein the detecting of the user input is taken from the group consisting of: detecting a button press of a mechanical button, detecting a button press on a touch screen, detecting a sound, detecting a touch pad press, and detecting a mouse click;
(b) initiating a generation of a dog vocalization sound in response to the detecting of (a);
(c) generating a digital image using the wireless mobile communication device, wherein the digital image is generated in (c) after the generation of the dog vocalization sound has been initiated in (b); and
(d) communicating the digital image to a destination via a wireless communication, wherein the destination of the communicated digital image is determined by the mobile app.

2. The mobile app of claim 1, wherein the mobile app controls the detecting of (a), the initiating of (b), the generating of (c), and the communicating of (d).

3. The mobile app of claim 1, wherein the dog vocalization sound is a dog whimper.

4. The mobile app of claim 3, wherein a duration of the dog vocalization sound is at least half of one second, wherein the dog vocalization sound has a strongest tone, and wherein a frequency of the strongest tone is at least five hundred hertz.

5. The mobile app of claim 1, wherein the mobile app prompts a user to rotate the digital image generated in (c).

6. The mobile app of claim 1, wherein the mobile app prompts a user to identify a facial feature of an animal appearing in the digital image generated in (c).

7. The mobile app of claim 1, wherein a digital audio file of the dog vocalization sound is stored on the mobile communication device, and wherein the generation of the dog vocalization sound that is initiated in (b) is a result of a playing of the digital audio file.

8. The mobile app of claim 1, wherein the digital image is an image of a dog.

9. The mobile app of claim 1, wherein the communicating to the destination of (d) causes digital image information from the wireless mobile communication device to be received by a computer-implemented facial recognition process executing on a server.

10. The mobile app of claim 1, wherein the communicating of the digital image in (d) causes a computer-implemented facial recognition process to derive facial recognition markers from the digital image.

11. The mobile app of claim 1, wherein the generating of (c) occurs automatically without any user button press after the initiating of (b).

12. The mobile app of claim 1, wherein the generating of (c) occurs in response to another button press that occurs after the initiating of (b).

13. The mobile app of claim 1, further comprising:
(e) providing a button on the wireless communication device that is selectable by a user to initiate second generation of the dog vocalization sound, wherein the button is provided before the digital image is generated in (c).

14. The mobile app of claim 1, wherein a repeated pressing of the button of (e) causes the dog vocalization sound to be repeatedly generated.

15. A method comprising:
(a) detecting user input on a wireless mobile communication device;
(b) initiating a generation of a dog vocalization sound in response to the detecting of (a);
(c) generating a digital image using the wireless mobile communication device, wherein the digital image is generated in (c) after the generation of the dog vocalization sound has been initiated in (b); and
(d) communicating the digital image to a destination at least in part via a wireless communication from the wireless mobile communication device, wherein the destination of the communicated digital image is determined by a mobile application (mobile app) executing on the wireless mobile communication device, and wherein the mobile app controls the detecting of (a), the initiating of (b), the generating of (c), and the communicating of (d).

16. The method of claim 15, wherein the dog vocalization sound is a dog whimper, wherein a duration of the dog vocalization sound is at least half of one second, wherein the dog vocalization sound has a strongest tone, and wherein a frequency of the strongest tone is at least five hundred hertz.

17. The method of claim 15, wherein a digital audio file of the dog vocalization sound is stored on the wireless mobile communication device, and wherein the generation of the dog vocalization sound that is initiated in (b) is a result of playing of the digital audio file.

18. The method of claim 15, further comprising:
(e) prompting a user of the wireless mobile communication device to manipulate the digital image, wherein the prompting of (e) is controlled by the mobile app.

19. The method of claim 15, wherein the communicating to the destination of (d) causes digital image information from the wireless mobile communication device to be received by a computer-implemented facial recognition process executing on a server.

20. An apparatus comprising:
a touch screen of a wireless mobile communication device; and
means for: 1) causing a button to be displayed on the touch screen, 2) for causing the wireless mobile communication device to generate a dog vocalization sound in response to a detecting of a pressing of the button, 3) for causing a digital image of a dog to be captured using the wireless mobile communication device, and 4) for causing digital image information to be communicated from the wireless mobile communication device, wherein the digital image information includes information derived from the captured digital image, and wherein the means comprise a mobile app executing on the wireless mobile communication device.
